(19) United States
(12) Patent Application Publication
(10) Pub. No.: US 2010/0211446 A1
(43) Pub. Date: Aug. 19, 2010

(54) METHODS AND APPARATUS FOR ADVERTISEMENT MIXINGI N A COMMUNICATION SYSTEM

(75) Inventor: Rajarshi Ray, San Diego, CA (US)

Correspondence Address: QUALCOMM INCORPORATED, 5775 MOREHOUSE DR., SAN DIEGO, CA, 92121, US

(73) Assignee: QUALCOMM Incrporated, San Diego, CA (US)

(21) Appl. No.: 12/485,702

(22) Filed: Jun. 16, 2009

Related U.S. Application Data
(60) Provisional application No. 61/162,772, filed on Mar. 24, 2009.
(60) Provisional application No. 61/152,772, filed on Feb. 16, 2009.

(51) Int. Cl. G06Q 30/00; H04M 3/42

(52) U.S. Cl. 705/14.19; 705/14.73; 705/14.58; 705/14.66; 705/14.61; 705/14.55; 705/14.1; 705/14.39; 455/414.1

(57) ABSTRACT

Methods and apparatus for advertisement mixing in a communication system. A method operable by a network node includes determining an advertisement associated with a communication device, mixing the advertisement with a call service to be provided to the communication device, and transmitting the advertisement and the call service to the communication device. An apparatus includes a receiver configured to receive a call service, processing module configured to obtain an advertisement associated with the call service, and rendering module configured to render the advertisement.

### CLAIM OF PRIORITY UNDER 35 U.S.C. §119

The present Application for Patent claims priority to Provisional Application No. 61/152,772 entitled “Mixer For Communication Systems Advertisement” filed Mar. 25, 2009, and assigned to the assignee hereof and hereby expressly incorporated by reference herein.

### BACKGROUND

1. Field

The present application relates generally to the operation of wireless communication systems, and more particularly, to methods and apparatus for advertisement mixing in a communication system.

2. Background

Services offered by today's carriers and service providers, such as, Caller Identification (ID) or Caller Ring-Back Tones (CRBTs), allow the user to see the phone number of the caller on a display or hear a ringing tone when placing a call. The carriers generally offer these features as premium services and charge additional fees to the user. In the caller ID case, the phone generally displays the caller identification information. In the CRBT case, the caller hears a pre-selected ring-tone and generally has no option to skip it or alter it. In both of these cases, and in other similar call services, such as call transfer, hold, three-way conferencing, etc, these services operate to provide to the device users only basic information associated with the particular service.

The network carriers and service providers would like to have mechanisms to allow various advertisements (ADs) to be presented to device users in order to generate more revenue from the same user-base. For example, the advertisements may be context-based, location-based or even time-based advertisements. For example, a location-based advertisement is associated with the device user's current geographic location and may be offered to allow the device user to take advantage of special promotions offered within the local region. Context-based advertisements are associated with a device user's history or profile so that selected advertisements can be targeted to specific device users. Time-based advertisements are designed to be viewed by device users at a particular time of day.

Therefore, it would be desirable to have a mechanism that operates to allow context-based, location-based or time-based advertisements to be presented to device users when utilizing a variety of call services.

### SUMMARY

In one or more aspects, an AD mixer system, comprising methods and apparatus, is provided that operates to present advertisements to device users when utilizing a variety of call services in a communication network.

In an aspect, a method is provided that is operable by a network node for providing advertisements in a communication network. The method comprises determining an advertisement associated with a communication device, mixing the advertisement with a call service to be provided to the communication device, and transmitting the advertisement and the call service to the communication device.

In an aspect, an apparatus for providing advertisements in a communication network is disclosed. The apparatus comprises means for determining an advertisement associated with a communication device, means for mixing the advertisement with a call service to be provided to the communication device, and means for transmitting the advertisement and the call service to the communication device.

In an aspect, an apparatus for providing advertisements in a communication network is disclosed. The apparatus comprises a generator module configured to determine an advertisement associated with a communication device, a mixing module configured to mix the advertisement with a call service to be provided to the communication device, and a transmitter configured to transmit the advertisement and the call service to the communication device.

In an aspect, a computer program product for providing advertisements in a communication network is disclosed. The computer program produce comprises a computer-readable medium embodying codes executable to determine an advertisement associated with a communication device, mix the advertisement with a call service to be provided to the communication device, and transmit the advertisement and the call service to the communication device.

In an aspect, a method is provided that is operable by a communication device for providing advertisements in a communication network. The method comprises receiving a call service, obtaining an advertisement associated with the call service, and rendering the advertisement on a communication device.

In an aspect, an apparatus for providing advertisements in a communication network is disclosed. The apparatus comprises means for receiving a call service, means for obtaining an advertisement associated with the call service, and means for rendering the advertisement.

In an aspect, an apparatus for providing advertisements in a communication network is disclosed. The apparatus comprises a receiver configured to receive a call service, processing module configured to obtain an advertisement associated with the call service, and rendering module configured to render the advertisement.

In an aspect, a computer program product for providing advertisements in a communication network is disclosed. The computer program product comprises a computer-readable medium embodying codes executable to receive a call service, obtain an advertisement associated with the call service, and render the advertisement.

Other aspects will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following Description when taken in conjunction with the accompanying drawings wherein:

FIG. 1 shows an exemplary communication network that illustrates aspects of an AD mixer system;

FIG. 2 shows an exemplary AD server for use in aspects of an AD mixer system;

FIG. 3 shows an exemplary method for mixing ADs with call services for use in aspects of an AD mixer system;

FIG. 4 shows an exemplary method for generating ADs for use in aspects of an AD mixer system;

FIG. 5 shows an exemplary method for providing AD mixing for call origination services for use in aspects of an AD mixer system;

FIG. 6 shows an exemplary method for providing AD mixing for call destination services for use in aspects of an AD mixer system;

FIG. 7 shows an exemplary AD receiver for use in aspects of an AD mixer system;

FIG. 8 shows an exemplary method for receiving ADs mixed with call services for use in aspects of an AD mixer system;

FIG. 9 shows an exemplary AD server for use in aspects of an AD mixer system; and

FIG. 10 shows exemplary AD receiver for use in aspects of an AD mixer system.

### DESCRIPTION

The following description describes aspects of an AD mixer system that operates to present advertisements to device users when utilizing a variety of call services in a communication network. For example, the system operates to generate and mix advertisements or any other information with call services to be provided to one or more devices. The advertisements are rendered on the devices during the call service or may be stored and rendered at a later time. For example, the ADs comprise images, text, audio, video, animations, or any other type of AD content. The ADs may be static or interactive so that device users may interact with the advertisements to obtain more information, additional ADs, enable AD forwarding, or to initiate any other type of service or AD processing.

In various aspects, the AD mixer system comprises an AD server and an AD mixer that operate to provide location-based, context-based, and/or time-based advertisements. In an aspect, the AD mixer system operates to render different types of multimedia ADs on a device display and/or through device speakers when selected call services are provided. For example, based on the nature of the call and the location of the device, selected regional ADs are presented to the user on a device display. In the case of the CRBT, ADs are provided in audio format. The user is defined as the person receiving the call in the case of the caller ID or the person originating the call in the case of the CRBT. In either case, the AD mixer system determines the user's location from one of a corresponding home location register (HLR) and visiting location register (VLR), or from information determined from a GPS device on the user's handset. Once the location is determined, an appropriate AD will be selected (randomly, or based on the user's profile, if desired) and subsequently mixed into the audio/video stream being transmitted to the user. The user will be subsequently given the option to interact with the AD through soft-buttons on the display or various keys placed on the handset keyboard. In another aspect, the ADs can also be selected by means of built-in intelligence in the communication system based on a user profile (i.e., past history, habits and/or patterns). Some of this historical information can be retrieved from the carrier's database or the local memory of the user's handset.

The advertisements provide additional revenue sources for carriers or service providers. In fact, the underlying service may be offered free to the user and still generate sufficient AD revenue for the carrier. For example, in an aspect, a pre-paid user may receive free additional call minutes for participating and/or opting in to receive advertisements.

In the case of a caller ID service with ADs, the user will be given an option to answer the call, not answer the call but respond to the advertisement only, or do nothing. In the case of the CRBT, the caller will have the option to bypass the ringtone selected by the called party and listen to some advertisements instead (for a discounted charge for the call). To make these advertisements relevant to the users, the ADs are made contextual or location-based (or time-based, for example, ADs for night-time products will only be offered during the evening or night-time), depending on the location of the called party in the case of the caller ID or the location of the caller in case of the CRBTs. ADs can also be mixed in with other typical communication services, such as, 3-way calling, multi-party conference calls, video telephony, call hold and call transfer.

The AD mixer system results in tremendous benefits to the carrier, device user, and also the advertisers. With respect to the carrier, there is additional source of revenue for each call placed (i.e., through advertisement). With respect to the user, the advertisements can subsidize the cost of the call and provide relevant information to the user based on his location or context. The ADs may also offer the user an opportunity to interact with the AD which may entail a coupon, a concert ticket or a free ringtone or wallpaper. The user may also save the coupon and/or forward the call to his friends along with the coupon. With respect to the advertiser, more opportunities are provided to promote products to more people.

In an aspect, one or more ADs can be pushed to the user's handset during off-peak periods (e.g., night-time) on a daily, weekly or monthly basis. In the next few days, as the user participates in various communication services as a part of his/her daily activities, these ADs will be presented to the user.

The system is especially well suited for use in wireless network environments, but may be used in any type of network environment, including but not limited to, communication networks, public networks, such as the Internet, private networks, such as virtual private networks (VPN), local area networks, wide area networks, long haul network, or any other type of network.

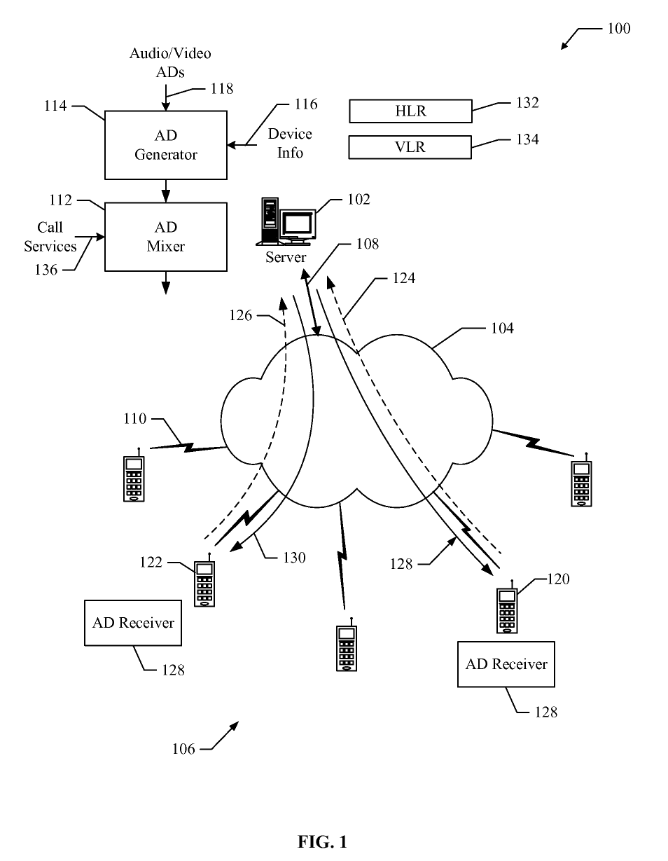

FIG. 1 shows a network 100 that illustrates aspects of an AD mixer system. The network 100 comprises AD server 102, network 104, and a plurality of devices shown generally at 106. The network 104 may be any type and/or combination of wired and wireless networks that allow data to be transmitted between the server 102 and the devices 106. Thus, the primary function of the network 104 is to facilitate communication between devices. The AD server 102 is coupled to the network 104 via the communication link 108, which may be any type of wired and/or wireless communication link that allows the AD server 102 to communicate with the network 104. The devices 106 comprise a mobile telephone, PDA, notebook computer, pager, email device, or any other type of device that is operable to communicate with the network 104. The devices 106 are in communication with the network 104 via wireless communication links 110, which allows data, voice or other information to be wirelessly transmitted between the network 104 and the devices 106. In an aspect, the wireless communication links 110 comprises forward communication channels, reverse communication channels, paging channels, control channels, broadcast/multicast channels and any other type of communication channel that may be used to communicate information between the network 104 and the devices 106.

It should also be noted that aspects of the AD mixer system are suitable for use with virtually any number of devices that communicate with the network 104 via wired and/or wireless communication links.

The AD server 102 comprises AD mixer 112 and AD generator 114. During operation, the AD server 102 receives or otherwise obtains device/user information 116 that comprises information associated with devices/users that are in communication with the server 102. For example, the information comprises device location information, user profiles, user histories or other information. In an aspect, device information 116 is determined from one or both of home location register 132 and visiting location register 134, or any other network entity. The information may also be received directly from the devices 106.

The AD generator 114 operates to utilize the device information 116 to determine one or more ADs to be transmitted to a particular device. In an aspect, the AD generator 114 received various audio and/or video ADs 118 and uses the device information 116 (i.e, device position, context, and time) to select ADs to be transmitted to the device. For example, the ADs comprise images, text, audio, video, animations, or any other type of AD content. The selected ADs are presented to the AD mixer 112.

The AD mixer 112 operates to mix the generated ADs with call services 136 provided by the AD server 102. For example, the call services comprise, but are not limited to, caller ID, call forwarding, three-way calling, call hold, etc. The call services and associated ADs are then provided to a particular device that has requested service or is to receive service. In another aspect, the generated ADs may be provided to the devices 106 in off-peak communications and stored at the devices 106 for later rendering.

The operation of the devices 106 is described with reference to the devices 120 and 122. The devices 120 and 122 operate to communicate with the network 104. These communications comprise call related communications and device related communications. Call related communications are those communications associated with call set-up, initiation, reception, transmission or any other call related communication. For example, the device 122 may communicate with the server 102 to initiate a call to the device 120.

The device related communications are those communications associated with the operation of a particular device. For example, the device communications comprise, but are not limited to, device operating parameters, signal strengths, geographic location indicators, device mobility indicators or other device related information. The device information also comprises user information such as call histories, user profile information or any other type of user information. In an aspect, the call and device information are transmitted from the devices 120 and 122 to the AD server 102 as shown at 124 and 126, respectively.

### Exemplary Call Processing

The following description describes aspects of the AD mixer system with respect to call processing. For example, the AD mixer system operates when the device 122 places a call to the device 120. During operation, the devices 120 and 122 provide device information to the server 102. For example, the device information comprises device location, user profile information or other information.

When the device 122 initiates a call to the device 120, the AD server 102 begins the process of notifying the device 120 about the incoming call. The AD generator 114 utilizes information about the call initiator (device 122) to generate one or more ADs to be transmitted to this initiator. The AD generator 114 also utilizes information about the call receiver (device 120) to generate one or more ADs to be transmitted to this receiver. The generated ADs are determined based on device location, context or time.

The AD mixer 112 operates to mix the determined AD(s) for the call receiver (device 120) with call services to be provided to that device. For example, a caller ID service may be provided to the device 120 to notify the device 120 that the device 122 is attempting to connect a call. The AD mixer 122 includes the generated AD(s) for the device 120 in the caller ID information that is transmitted to the device 120, as illustrated at 128.

Similarly, the AD mixer 112 operates to mix the determined AD(s) for the call initiator (device 122) with call services to be provided to that device. For example, a CRBT service may be provided to the device 122 to notify the device 122 that the call is being processed. The AD mixer 122 includes the generated AD(s) for the device 122 in the CRBT service that is transmitted to the device 122 as illustrated at 130.

Each device comprises AD receiver 128. The AD receiver 128 operates to decode ADs mixed in with call services received from the AD server 102. For example, the device 120 receives the AD mixed in with the call ID service and the device 122 receives the AD mixed in with the CRBT service. The AD receiver 128 at each device operates to render received ADs using a device display or sound system. For example, the AD receiver 128 at the device 120 renders the AD received with the caller ID service on the device display. The AD receiver 128 at the device 122 renders the AD received with the CRBT service using the device sound system. Thus, each device is assigned ADs based on device location, context and/or time and those ADs are delivered as part of call services provided by the AD server 102.

In another aspect, ADs are delivered to the devices 106 during off-peak times and stored in an advertisement inbox at each device. When receiving a call service, the AD receiver 128 operates to obtain selected ADs from the advertisement inbox and present these ADs to the device user.

In another aspect, the AD receiver 128 operates to allow device users to interact with the ADs by receiving from the device users key-press responses that are transmitted back to the AD server 102. These responses allow the device users to obtain additional information about the subject of the AD or perform any other function related to the AD. For example, a device user may be provided with a service discount or extended call times by agreeing to receive and/or view a selected AD.

Therefore, in one or more aspects, an AD mixer system is provided that operates to provide advertisement information to devices in a communication network. It should be noted that the network 100 is just one implementation and that other implementations are possible within the scope of the aspects.

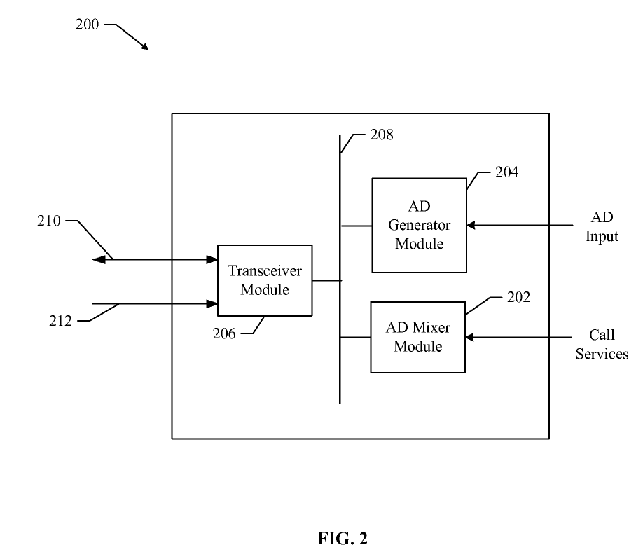

FIG. 2 shows an exemplary AD server 200 that operates to provide aspects of an AD mixer system. For example, the AD server 200 is suitable for use as the AD server 102 shown in FIG. 1. The AD server 200 comprises AD mixer module 202, AD generator module 204, and transceiver module 206 all coupled to a data bus 208. It should be noted that the AD server 200 is just one implementation and that other implementations are possible within the scope of the aspects.

The transceiver module 206 comprises hardware and/or hardware executing software that operates to allow the AD server 200 to communicate data or other information over a network with remote devices or systems. In an aspect, the transceiver module 206 is operable to receive device information from devices in communication with a network via communication link 212. In an aspect, the device information comprises position indicators, mobility indicators, user profiles and any other device information.

In an aspect, the transceiver module 206 is operable to provide call services to devices in communication with a network via service link 210. For example, the call services comprise, but are not limited to, caller ID, CBRT, call waiting, call hold, three-way calling, and any other type of call service. For example, a device request to initiate a voice call may be received over the communication link 210. The communication link 210 may also be used to notify a device about an incoming call. The operation of the transceiver module 206 to obtain device information and provide call services is described in more detail below.

In one or more aspects, the AD mixer module 202 comprises at least one of a CPU, processor, gate array, hardware logic, memory elements, and/or hardware executing software. In an aspect, the AD mixer module 202 operates to receive requests for call services. For example, in an aspect, the requests for call services received by other modules at the AD server 200 and provide to the AD mixer module 202. The requests for call services identify one or more devices to which the services are to be provided. The AD mixer module 202 operates to send the device identification information to the AD generator module 204. The AD generator module 204 operates to generate one or more ADs to be provided to the devices in conjunction with the provided call services. The generated ADs are then passes from the AD generator module 204 to the AD mixer module 202. The AD mixer module 202 operates to mix the ADs with the call services and passes this information to the transceiver module 206 for transmission to the associated devices.

The AD generator module 204 comprises at least one of a CPU, processor, gate array, hardware logic, memory elements, and/or hardware executing software. The AD generator module 204 operates to receive ADs to be mixed with call services. For example, the ADs may be received from another module at the AD server 200, a network carrier, or a content provider. For example, the ADs comprise images, text, audio, video, animations, or any other type of AD content. The AD generator module 204 receives the identifiers of devices associated with a call service from the AD mixer module 202. The AD generator module 204 also receives device information from the transceiver module 206. The AD generator module 204 processes the device identifiers and the device information to select ADs to be provided to devices in conjunction with the call services. A more detailed description of the operation of the AD generator logic 204 is provided below

In an aspect, the AD mixer system comprises a computer program product having one or more program instructions (“instructions”) or sets of “codes” stored or embodied on a machine-readable medium. When the codes are executed by at least one processor, for instance, a processor at the AD mixer module 202, their execution causes the processor to provide the functions of the AD mixer system described herein. For example, the machine-readable medium comprises a floppy disk, CDROM, memory card, FLASH memory device, RAM, ROM, or any other type of memory device or machine-readable medium that interfaces to the AD server 200. In another aspect, the sets of codes may be downloaded into the AD server 200 from an external device or communication network resource. The sets of codes, when executed, operate to provide aspects of an AD mixer system as described herein.

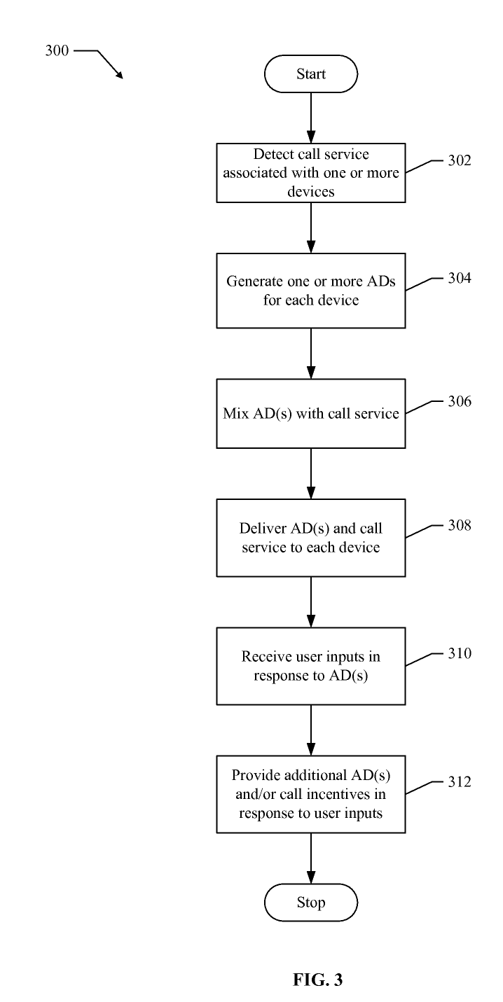

FIG. 3 shows an exemplary method 300 operable at a server for mixing ADs with call services for use in aspects of an AD mixer system. For clarity, the method 300 is described below with reference to the AD server 200 shown in FIG. 2. In an aspect, the AD mixer module 202 executes one or more sets of codes to control the AD server 200 to perform the functions described below.

At block 302, a call service to be provided to one or more devices is detected. In an aspect, the AD mixer module 202 detects the call service. For example, the call service may be associated with a call initiation, call notification or any other type of call service. Additionally, the call service may be associated with more than one device. For example, the call service may be associated with a three-way call and therefore be associated with three devices. In an aspect, the AD mixer module 202 identifies the devices associated with the call service and passes this information to the AD generator module 204.

At block 304, one or more ADs are generated for each device associated with the call service. In an aspect, the AD generator module 204 generates these ADs. For example, if the call service is a caller ID service, an AD is generated for the device that is to receive the call. If the call service is a CRBT service, an AD is generated for the device that initiated the call and is to receive the CRBT.

At block 306, the generated ADs are mixed with the call services for delivery to devices. In an aspect, the AD mixer module 202 performs this function. For example, the AD mixer module 202 receives the generated ADs from the AD generator module 204 and mixes these ADs with the call service information to be provided to one or more devices. For example, the AD may be video information in a video file that is included with caller ID information that is to be delivered to a device receiving an incoming call. In another aspect, the AD may be audio information in an audio file that is included with CRBT information to be delivered to a device initiating a call.

At block 308, the mixed ADs and call service is delivered to each device. In an aspect, the transceiver module 206 operates to deliver the mixed ADs and call services to devices using the communication link 210.

At block 310, user inputs are received in response to the ADs. For example, user inputs in response to an AD rendered at a communication device are transmitted to the server 200.

At block 312, in response to the user inputs additional ADs and/or call incentives are provided. For example, the server 200 operates to select additional ADs and transmit them to the user's device in response to the user's inputs. In another aspect, the server 200 operates to provide one or more call incentives, such as extending the call duration or reducing the cost of the call, based on the user's inputs.

Therefore, the method 300 operates to generate and mix ADs with call services for use in aspects of an AD mixer system. It should be noted that the method 300 is just one implementation and that the operations of the method 300 may be rearranged or otherwise modified within the scope of the various aspects. Thus, other implementations are possible with the scope of the various aspects described herein.

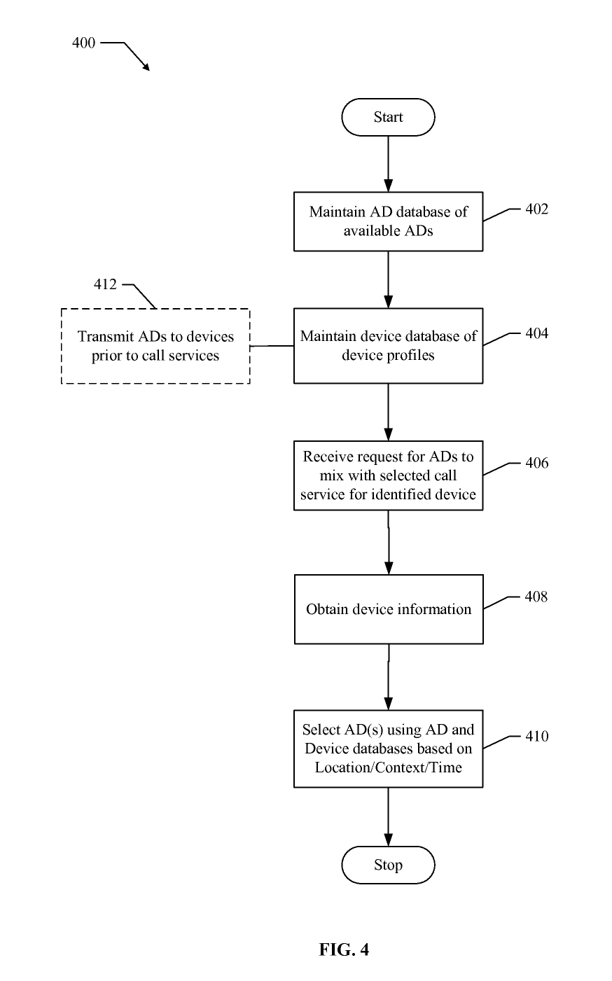

FIG. 4 shows an exemplary method 400 for generating ADs for use in aspects of an AD mixer system. For example, the method 400 is suitable for use at block 304 of the method 300. For clarity, the method 400 is described below with reference to the AD server 200 shown in FIG. 2. In an aspect, the AD generator module 204 executes one or more sets of codes to control the AD server 200 to perform the functions described below.

At block 402, a database of available ADs is maintained. In an aspect, the AD generator module 204 operates to maintain the database of available ADs. For example, the AD generator module 204 obtains ADs from other modules (not shown) at the AD server 200. The ADs are organized into various categories. For example, the ADs may be organized by location, context, and/or time.

At block 404, a database of device profiles is maintained. In an aspect, the AD generator module 204 operates to maintain the database of device profiles. For example, the device profiles comprise information about devices in communication with a communication network. In an aspect, the device profiles comprise information such as call histories, home locations, or any other device profile information.

At block 412, in an optional operation, ADs are transmitted to devices prior to call services. For example, ADs are selected for a particular device and transmitted during off-peak times prior to providing selected call services. The devices store the received ADs in an advertisement inbox for later processing when the selected call services are received.

At block 406, a request is received for AD(s) to be mixed with call services to be provided to one or more devices. In an aspect, the AD generator module 204 receives this request from the AD mixer module 202. The request includes an identification of the devices associated with the call services to be provided.

At block 408, device information is obtained. In an aspect, the AD generator logic 204 obtains device information from the transceiver module 206. The device information comprises device location, user profile, mobility indicators or any other type of device information.

At block 410, one or more ADs are selected based on the device information, the AD database, and the device profile database. In an aspect, the AD generator logic 204 operates to select the ADs based on device location, context, or time. For example, ADs may be selected from the AD database based on a device's current location or the current time of day. ADs may also be selected based on context and/or time of day. Once the ADs are generated, the AD generator module 204 forwards the ADs to the AD mixer module 202.

Therefore, the method 400 operates to generate ADs for use in aspects of an AD mixer system. It should be noted that the method 400 is just one implementation and that the operations of the method 400 may be rearranged or otherwise modified within the scope of the various aspects. Thus, other implementations are possible with the scope of the various aspects described herein.

FIG. 5 shows an exemplary method 500 for providing AD mixing for call origination services for use in aspects of an AD mixer system. For clarity, the method 300 is described below with reference to the AD server 200 shown in FIG. 2. In an aspect, the AD mixer module 202 executes one or more sets of codes to control the AD server 200 to perform the functions described below.

At block 502, a need for call origination services associated with a source device is detected. For example, call origination services are provided when a source device initiates a call to a destination device. For example, one type of call origination service is a CRBT. In an aspect, the AD mixer module 202 detects that call origination services are needed for the source device.

At block 504, one or more ADs are generated for the source device. For example, the AD generator module 204 generates the AD(s) in accordance with the method 400 described above.

At block 506, the generated Ad(s) are mixed with the call origination services. In an aspect, the AD mixer module 202 mixes the generated AD(s) with the call origination services.

At block 508, the AD(s) and call origination services are delivered to the source device. In an aspect, the transceiver module 206 delivers the AD(s) and call origination services to the source device over the communication link 210.

Therefore, the method 500 operates to provide AD mixing for call origination services for use in aspects of an AD mixer system. It should be noted that the method 500 is just one implementation and that the operations of the method 500 may be rearranged or otherwise modified within the scope of the various aspects. Thus, other implementations are possible with the scope of the various aspects described herein.

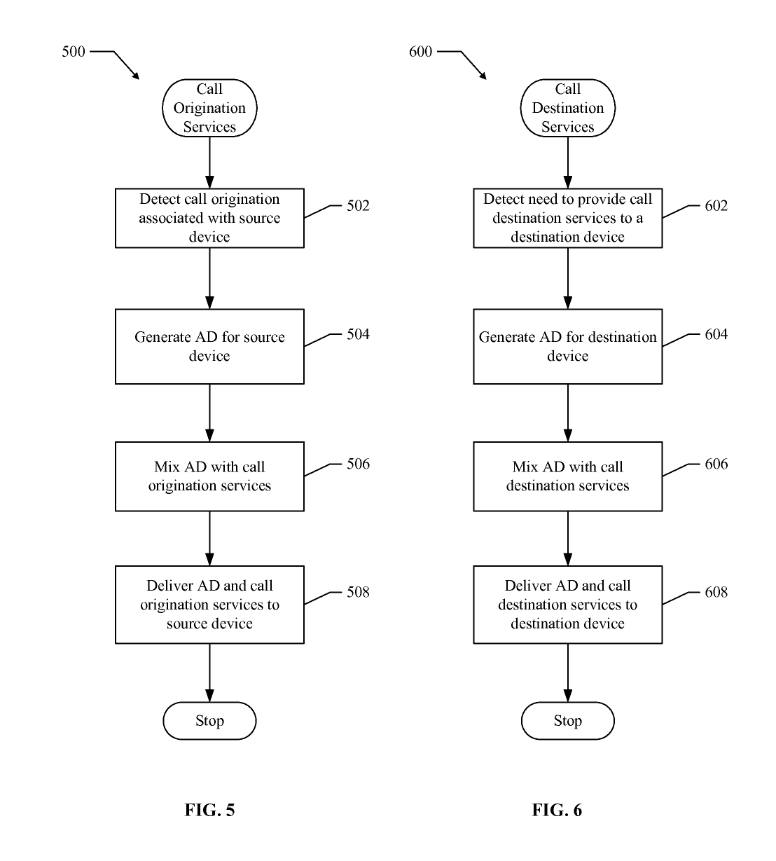

FIG. 6 shows an exemplary method 600 for providing AD mixing for call destination services for use in aspects of an AD mixer system. For clarity, the method 600 is described below with reference to the AD server 200 shown in FIG. 2. In an aspect, the AD mixer module 202 executes one or more sets of codes to control the AD mixer server 200 to perform the functions described below.

At block 602, a need for call destination services associated with a destination device is detected. For example, call destination services are provided when a source device initiates a call to a destination device. For example, one type of call destination service is caller ID. In an aspect, the AD mixer module 202 detects that call destination services are needed for the destination device.

At block 604, one or more ADs are generated for the destination device. For example, the AD generator module 204 generates the AD(s) in accordance with the method 400 described above.

At block 606, the generated Ad(s) are mixed with the call destination services. In an aspect, the AD mixer module 202 mixes the generated AD(s) with the call destination services.

At block 608, the AD(s) and call destination services are delivered to the destination device. In an aspect, the transceiver module 206 delivers the AD(s) and call destination services to the destination device over the communication link 210.

Therefore, the method 600 operates to provide AD mixing for call destination services for use in aspects of an AD mixer system. It should be noted that the method 600 is just one implementation and that the operations of the method 600 may be rearranged or otherwise modified within the scope of the various aspects. Thus, other implementations are possible with the scope of the various aspects described herein.

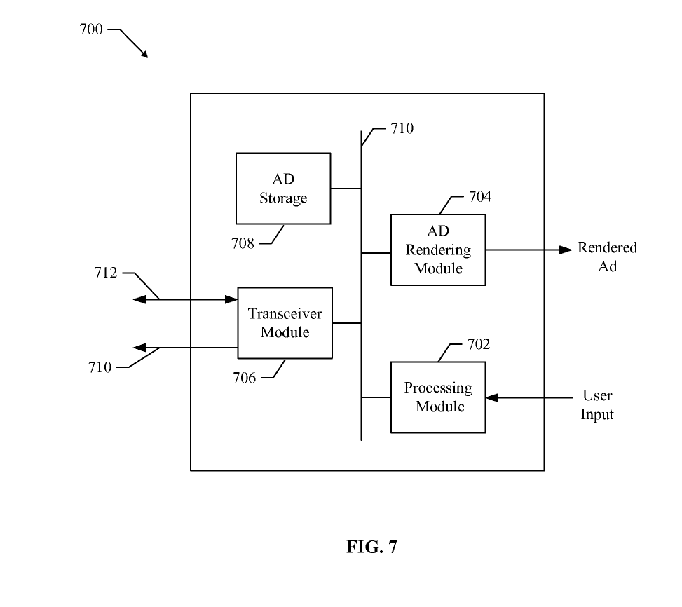

FIG. 7 shows an exemplary AD receiver 700 for use in aspects of an AD mixer system. For example, the AD receiver 700 is suitable for use as the AD receiver 128 shown in FIG. 1. The AD receiver 700 comprises processing module 702, AD rendering module 704, transceiver module 706, and AD storage module 708 all coupled to a data bus 710. It should be noted that the AD receiver module 700 represents just one implementation and that other implementations are possible within the scope of the aspects.

The processing module 702 comprises at least one of a CPU, processor, gate array, hardware logic, memory elements, and/or hardware executing software. Thus, the processing module 702 generally comprises logic to execute machine-readable instructions and to control one or more other functional elements of the AD receiver 700 via the data bus 708.

The AD storage module 708 comprises any suitable storage device operable to store ADs. In an aspect, the AD storage module 708 comprises an AD inbox that is operable to store ADs received with call services and ADs received in off-peak transmissions. The processing module 702 is operable to retrieve ADs from the AD inbox to be associated with one or more call services.

The AD rendering module 704 comprises hardware and/or hardware executing software to allow the AD receiver 700 to render ADs to a device user. For example, the ADs comprise images, text, audio, video, animations, or any other type of AD content that the AD rendering module 704 processes to render to a device user. The ADs are rendered on a device display and/or through a device audio system.

The transceiver module 706 comprises hardware and/or hardware executing software that operates to allow the AD receiver 700 to transmit and receive data, ADs, call services, and any other information with external devices or systems. For example, the transceiver module 706 is operable to transmit device information over a communication link 710 to a network server. In an aspect, the network server is the AD server 102 shown in FIG. 1. The device information comprises a device position, call histories, user profiles, mobility indicators or any other type of device information. In another aspect, the transceiver module 706 is operable to receive call services mixed with ADs over a communication link 712.

During operation, call services mixed with ADs are received at the transceiver module 760. The call services may be associated with call initiation or call destination services. The call services are passed to the processing module 702. The processing module 702 operates to decode the ADs mixed in with the call services and provides the ADs to the AD rendering module 704. The AD rendering module 704 operates to render the ADs to a device user.

In an aspect, the device user may interact with the ADs by providing user input to the processing module 702. The user inputs are then transmitted to an network AD server that operates to either provide additional ADs and/or call incentives.

In another aspect, ADs are received prior to call services and stored in the AD inbox. For example, the transceiver module 706 receives the ADs in off-peak transmissions and passes the ADs to the processing module 702 for storage in the AD inbox. When a call service is received, the processing module 702 operates to retrieve ADs associated with the call service from the AD inbox. Thus, ADs may be mixed with a call service or received in advance and stored in the AD inbox for later rendering. A more detailed description of the operation of the AD receiver 700 is provided below.

In an aspect, the AD mixer system comprises a computer program product having one or more program instructions (“instructions”) or sets of “codes” stored or embodied on a machine-readable medium. When the codes are executed by at least one processor, for instance, a processor at the processing module 702, their execution causes the processor to provide the functions of the AD mixer system described herein. For example, the machine-readable medium comprises a floppy disk, CDROM, memory card, FLASH memory device, RAM, ROM, or any other type of memory device or machine-readable medium that interfaces to AD receiver 700. In another aspect, the sets of codes may be downloaded into the AD receiver 700 from an external device or communication network resource. The sets of codes, when executed, cause the AD receiver 700 to provide aspects of an AD mixer system as described herein.

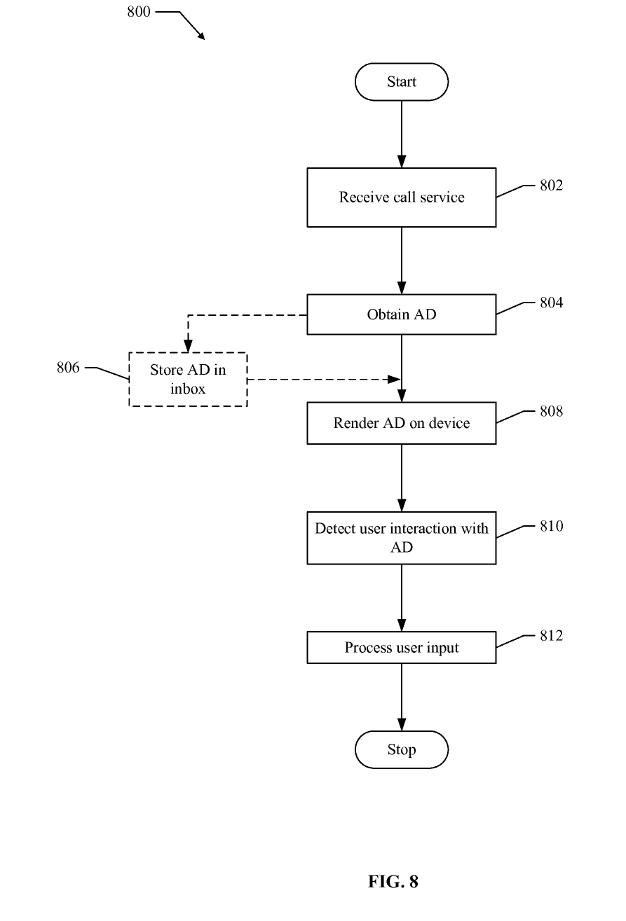

FIG. 8 shows an exemplary method 800 for receiving ADs for use in aspects of an AD mixer system. For clarity, the method 800 is described below with reference to the AD receiver 700 shown in FIG. 7. In an aspect, the processing module 702 executes one or more sets of codes to control the AD receiver 700 to perform the functions described below.

At block 802, a call service is received. In an aspect, the transceiver module 706 receives the call service and passes the received information to the processing module 702. For example, the call service may be a caller ID service or a CRBT service.

At block 804, an AD associated with the call service is obtained. For example, in one implementation the AD is decoded from the call service information. In another implementation, the AD is retrieve from an AD inbox where it was previously stored. In an aspect, the transceiver module 706 passes the receive call service to the processing module 702 and the processing module 702 operates to obtain the AD that is either mixed in with the received call service or retrieved from the AD inbox.

At block 806, in an optional operation, the AD is stored for later processing. In an aspect, if the AD is mixed in with the call service, the processing module 702 operates to store the AD in the AD inbox for later rendering.

At block 808, the AD is rendered. In an aspect, the processing logic 702 passes the AD to the AD rendering module 704 where it is rendered. For example, the AD may be displayed on a device display or played on a device audio system.

At block 810, user interaction with the AD is detected. In an aspect, once the AD is rendered, a device user may provide user input to interact with the AD. The user input allows the device user to make selections, agree to terms, or initiate any other functions. In an aspect, the processing module 702 operates to receive and process the user input.

At block 812, the user input is processed. In an aspect, the processing module 702 operates to perform any functions in response to the user input. For example, such functions include, but are not limited to, agreeing to the terms of the AD, transmitting the AD to another party, agreeing to view additional ADs, or any other functions. The processing module 702 works in conjunction with the AD rendering module 704 to allow user interaction with the AD and to provide additional rendered content. In one implementation, the user input is transmitted to an AD server for the purpose of obtaining additional ADs and/or call incentives as described above.

Therefore, the method 800 operates to receive ADs in aspects of an AD mixer system. It should be noted that the method 800 is just one implementation and that the operations of the method 800 may be rearranged or otherwise modified within the scope of the various aspects. Thus, other implementations are possible with the scope of the various aspects described herein.

### Additional Functions

The following is a description of additional functions that are provided by aspects of the AD mixer system. It should be noted that the functions described below are exemplary and that the AD mixer system is operable to combine, modify, or provide virtually any type of AD mixing function. In an aspect, the AD mixer system performs one or more of the following functions based on user input in response to an interactive AD.
1. Requesting a new advertisement
2. Forwarding the advertisement
3. Deleting the advertisement
4. Storing the advertisement
5. Receiving the advertisement while ignoring the call service
6. Receiving the call service while ignoring the advertisement

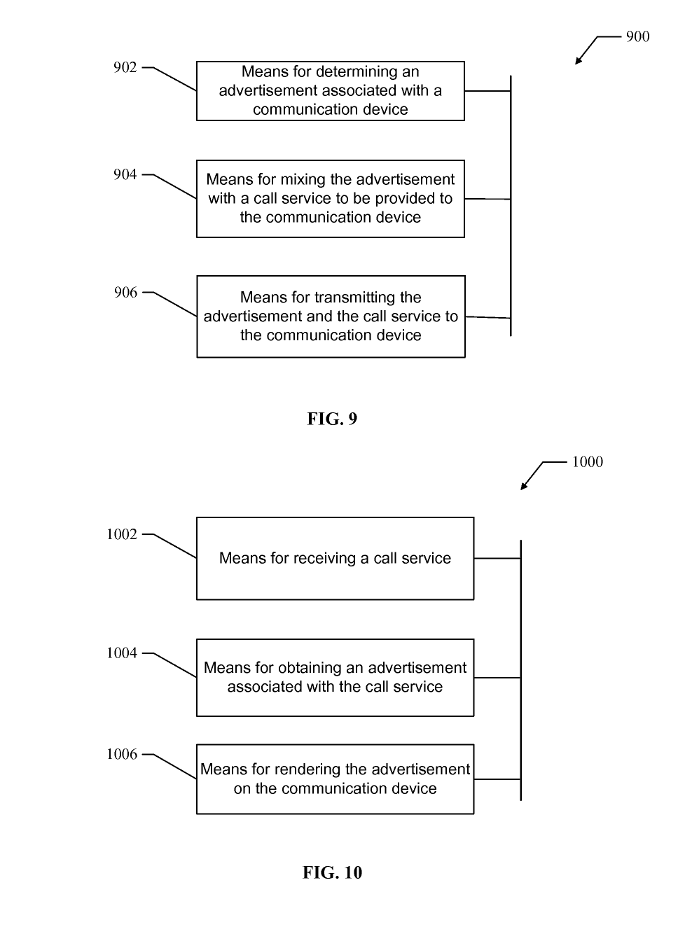

FIG. 9 shows an exemplary AD server 900 for use in aspects of an AD mixer system. For example, the AD server 900 is suitable for use as the AD server 102 shown in FIG. 1. In an aspect, the server 900 is implemented by at least one integrated circuit comprising one or more modules configured to provide aspects of an AD mixer system as described herein. For example, in an aspect, each module comprises hardware and/or hardware executing software.

The AD server 900 comprises a first module comprising means (902) for determining an advertisement associated with a communication device, which in an aspect comprises the AD generator 204. The AD server 900 also comprises a second module comprising means (904) for mixing the advertisement with a call service to be provided to the communication device, which in an aspect comprises the AD mixer 202. The AD server 900 also comprises a third module comprising means (906) for transmitting the advertisement and the call service to the communication device, which in an aspect comprises the transceiver 206.

FIG. 10 shows an exemplary AD receiver 1000 for use in aspects of an AD mixer system. For example, the AD receiver 1000 is suitable for use as the AD receiver 128 shown in FIG. 1. In an aspect, the AD receiver 1000 is implemented by at least one integrated circuit comprising one or more modules configured to provide aspects of an AD mixer system as described herein. For example, in an aspect, each module comprises hardware and/or hardware executing software.

The AD receiver 1000 comprises a first module comprising means (1002) for receiving a call service, which in an aspect comprises the transceiver module 706. The AD receiver 1000 also comprises a second module comprising means (1004) for obtaining an advertisement associated with the call service, which in an aspect comprises the processing module 702. The AD receiver 1000 also comprises a third module comprising means (1006) for rendering the advertisement on the communication device, which in an aspect comprises the rendering module 704.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a wireless communication device. In the alternative, the processor and the storage medium may reside as discrete components in a wireless communication device.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of an AD mixer system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method operable by a network node for providing advertisements in a communication network, the method comprising:
determining an advertisement associated with a communication device;
mixing the advertisement with a call service to be provided to the communication device; and
transmitting the advertisement and the call service to the communication device.

2. The method of claim 1, wherein the call service is at least one of a caller identifier service, a call ring-back tone service, a call transfer service, a call hold service, and a call conferencing service.

3. The method of claim 1, wherein the advertisement is at least one of a static advertisement and an interactive advertisement.

4. The method of claim 1, wherein the advertisement is at least one of a text file, audio file, animation file, and video file.

5. The method of claim 1, wherein said determining comprises determining the advertisement based on at least one of a home location register and a visiting location register.

6. The method of claim 1, wherein said determining comprises determining the advertisement based on a location indicator associated with the communication device.

7. The method of claim 1, wherein said determining comprises determining the advertisement based on a user profile associated with the communication device.

8. The method of claim 1, wherein said determining comprises determining the advertisement based on at least one of device location, device context, and time of day associated with the communication device.

9. The method of claim 1, further comprising receiving user input in response to the advertisement.

10. The method of claim 9, further comprising performing at least one additional function based on the user input, wherein the additional function is selected from a set comprising:
providing a new advertisement;
forwarding the advertisement; and
providing at least one call incentive.

11. The method of claim 10, wherein said providing the at least one call incentive comprise selecting the at least one call incentive from a set comprising:
extending a duration of a call associated with the call service; and
reducing costs of the call.

12. An apparatus for providing advertisements in a communication network, the apparatus comprising:
means for determining an advertisement associated with a communication device;
means for mixing the advertisement with a call service to be provided to the communication device; and
means for transmitting the advertisement and the call service to the communication device.

13. The apparatus of claim 12, wherein the call service is at least one of a caller identifier service, a call ring-back tone service, a call transfer service, a call hold service, and a call conferencing service.

14. The apparatus of claim 12, wherein the advertisement is at least one of a static advertisement and an interactive advertisement.

15. The apparatus of claim 12, wherein the advertisement is at least one of a text file, audio file, animation file, and video file.

16. The apparatus of claim 12, wherein said means for determining comprises means for determining the advertisement based on at least one of a home location register and a visiting location register.

17. The apparatus of claim 12, wherein said means for determining comprises means for determining the advertisement based on a location indicator associated with the communication device.

18. The apparatus of claim 12, wherein said means for determining comprises means for determining the advertisement based on a user profile associated with the communication device.

19. The apparatus of claim 12, wherein said means for determining comprises means for determining the advertisement based on at least one of device location, device context, and time of day associated with the communication device.

20. The apparatus of claim 12, further comprising means for receiving user input in response to the advertisement.

21. The apparatus of claim 20, further comprising means for performing at least one additional function based on the user input, wherein the additional function is selected from a set comprising:
providing a new advertisement;
forwarding the advertisement; and
providing at least one call incentive.

22. The method of claim 21, wherein said providing at least one call incentive comprises selecting the at least one call incentive from a set comprising:
extending a duration of a call associated with the call service; and
reducing costs of the call.

23. An apparatus for providing advertisements in a communication network, the apparatus comprising:
a generator module configured to determine an advertisement associated with a communication device;
a mixing module configured to mix the advertisement with a call service to be provided to the communication device; and
a transmitter configured to transmit the advertisement and the call service to the communication device.

24. The apparatus of claim 23, wherein the call service is at least one of a caller identifier service, a call ring-back tone service, a call transfer service, a call hold service, and a call conferencing service.

25. The apparatus of claim 23, wherein the advertisement is at least one of a static advertisement and an interactive advertisement.

26. The apparatus of claim 23, wherein the advertisement is at least one of a text file, audio file, animation file, and video file.

27. The apparatus of claim 23, wherein said generator module is configured to determine the advertisement based on at least one of a home location register and a visiting location register.

28. The apparatus of claim 23, wherein said generator module is configured to determine the advertisement based on a location indicator associated with the communication device.

29. The apparatus of claim 23, wherein said generator module is configured to determine the advertisement based on a user profile associated with the communication device.

30. The apparatus of claim 23, wherein said generator module is configured to determine the advertisement based on at least one of location, device context, and time of day associated with the communication device.

31. The apparatus of claim 23, wherein said mixer module is configured to receive user input in response to the advertisement.

32. The apparatus of claim 31, wherein said mixer module is configured to perform at least one additional function based on the user input, wherein the additional function is selected from a set comprising:
providing a new advertisement;
forwarding the advertisement; and
providing at least one call incentive.

33. The apparatus of claim 32, wherein said mixer module is configured to select the at least one call incentive from a set comprising:
extending a duration of a call associated with the call service; and
reducing costs of the call.

34. A computer program product for providing advertisements in a communication network, the computer program product comprising:
a computer-readable medium embodying codes executable to:
determine an advertisement associated with a communication device;
mix the advertisement with a call service to be provided to the communication device; and
transmit the advertisement and the call service to the communication device.

35. The computer-readable medium of claim 34, wherein the call service is at least one of a caller identifier service, a call ring-back tone service, a call transfer service, a call hold service, and a call conferencing service.

36. The computer-readable medium of claim 34, wherein the advertisement is at least one of a static advertisement and an interactive advertisement.

37. The computer-readable medium of claim 34, wherein the advertisement is at least one of a text file, audio file, animation file, and video file.

38. The computer-readable medium of claim 34, wherein said codes are configured to determine the advertisement based on at least one of a home location register and a visiting location register.

39. The computer-readable medium of claim 34, wherein said codes are configured to determine the advertisement based on a location indicator associated with the communication device.

40. The computer-readable medium of claim 34, wherein said codes are configured to determine the advertisement based on a user profile associated with the communication device.

41. The computer-readable medium of claim 34, wherein said codes are configured to determine the advertisement based on at least one of device location, device context, and time of day associated with the communication device.

42. The computer-readable medium of claim 34, wherein said codes are configured to receive user input in response to the advertisement.

43. The computer-readable medium of claim 42, wherein said codes are configured to perform at least one additional function based on the user input, wherein the additional function is selected from a set comprising:
providing a new advertisement;
forwarding the advertisement; and
providing at least one call incentive.

44. The computer-readable medium of claim 43, wherein said codes are configured to select the at least one call incentive from a set comprising:
extending a duration of a call associated with the call service; and
reducing costs of the call.

45. A method operable by a communication device for providing advertisements in a communication network, the method comprising:
receiving a call service;
obtaining an advertisement associated with the call service; and
rendering the advertisement on the communication device.

46. The method of claim 45, wherein said obtaining comprises:
receiving the advertisement mixed with the call service; and
obtaining the advertisement from the call service.

47. The method of claim 45, wherein said obtaining comprises:
maintaining an advertisement inbox;
storing one or more advertisements in an advertisement inbox;
identifying the advertisement in the inbox based on the call service; and
retrieving the advertisement from the advertisement inbox.

48. The method of claim 45, wherein the call service is at least one of a caller identifier service, a call ring-back tone service, a call transfer service, a call hold service, and a call conferencing service.

49. The method of claim 45, wherein the advertisement is at least one of a static advertisement and an interactive advertisement.

50. The method of claim 45, wherein the advertisement is at least one of a text file, audio file, animation file, and video file.

51. The method of claim 45, further comprising transmitting device location information to be used to select the advertisement.

52. The method of claim 45, further comprising receiving user input in response to the advertisement.

53. The method of claim 52, further comprising performing at least one additional function based on the user input, wherein the additional function is selected from a set comprising:
requesting a new advertisement;
forwarding the advertisement;
deleting the advertisement;
storing the advertisement;
agreeing to the terms of the advertisement;
receiving the advertisement while ignoring the call service; and
receiving the call service while ignoring the advertisement.

54. The method of claim 52, further comprising receiving at least one call incentive based on the user input, wherein the at least one call incentive is selected from a set comprising:
extending a duration of a call associated with a call service; and
reducing costs of the call.

55. An apparatus for providing advertisements in a communication network, the apparatus comprising:
means for receiving a call service;
means for obtaining an advertisement associated with the call service; and
means for rendering the advertisement.

56. The apparatus of claim 55, wherein said means for obtaining comprises:
means for receiving the advertisement mixed with the call service; and
means for obtaining the advertisement from the call service.

57. The apparatus of claim 55, wherein said means for obtaining comprises:
means for maintaining an advertisement inbox;
means for storing one or more advertisements in an advertisement inbox;
means for identifying the advertisement in the inbox based on the call service; and
means for retrieving the advertisement from the advertisement inbox.

58. The apparatus of claim 55, wherein the call service is at least one of a caller identifier service, a call ring-back tone service, a call transfer service, a call hold service, and a call conferencing service.

59. The apparatus of claim 55, wherein the advertisement is at least one of a static advertisement and an interactive advertisement.

60. The apparatus of claim 55, wherein the advertisement is at least one of a text file, audio file, animation file, and video file.

61. The apparatus of claim 55, further comprising means for transmitting device location information to be used to select the advertisement.

62. The apparatus of claim 55, further comprising means for receiving user input in response to the advertisement.

63. The apparatus of claim 62, further comprising means for performing at least one additional function based on the user input, wherein the additional function is selected from a set comprising:
requesting a new advertisement;
forwarding the advertisement;
deleting the advertisement;
storing the advertisement;
agreeing to the terms of the advertisement;
receiving the advertisement while ignoring the call service; and
receiving the call service while ignoring the advertisement.

64. The apparatus of claim 62, further comprising means for receiving at least one call incentive based on the user input, wherein the at least one call incentive is selected from a set comprising:
extending a duration of a call associated with a call service; and
reducing costs of the call.

65. An apparatus for providing advertisements in a communication network, the apparatus comprising:
a receiver configured to receive a call service;
processing module configured to obtain an advertisement associated with the call service; and
rendering module configured to render the advertisement.

66. The apparatus of claim 65, wherein said processing module is configured to:
receive the advertisement mixed with the call service; and
obtain the advertisement from the call service.

67. The apparatus of claim 65, wherein said processing module is configured to:
maintain an advertisement inbox;
store one or more advertisements in an advertisement inbox;
identify the advertisement in the inbox based on the call service; and
retrieve the advertisement from the advertisement inbox.

68. The apparatus of claim 65, wherein the call service is at least one of a caller identifier service, a call ring-back tone service, a call transfer service, a call hold service, and a call conferencing service.

69. The apparatus of claim 65, wherein the advertisement is at least one of a static advertisement and an interactive advertisement.

70. The apparatus of claim 65, wherein the advertisement is at least one of a text file, audio file, animation file, and video file.

71. The apparatus of claim 65, further comprising a transmitter configured to transmit device location information to be used to select the advertisement.

72. The apparatus of claim 65, wherein said processing module is configured to receive user input in response to the advertisement.

73. The apparatus of claim 72, wherein said processing module is configured to perform at least one additional function based on the user input, wherein the additional function is selected from a set comprising:
requesting a new advertisement;
forwarding the advertisement;
deleting the advertisement;
storing the advertisement;
agreeing to the terms of the advertisement;
receiving the advertisement while ignoring the call service; and
receiving the call service while ignoring the advertisement.

74. The apparatus of claim 72, wherein said processing module is configured to receive at least one call incentive based on the user input, wherein the at least one call incentive is selected from a set comprising:
extending a duration of a call associated with a call service; and
reducing costs of the call.

75. A computer program product for providing advertisements in a communication network, the computer program product comprising:
a computer-readable medium embodying codes executable to:
receive a call service;
obtain an advertisement associated with the call service; and
render the advertisement.

76. The computer-readable medium of claim 75, wherein said codes are configured to:
receive the advertisement mixed with the call service; and
obtain the advertisement from the call service.

77. The computer-readable medium of claim 75, wherein said codes are configured to:
maintain an advertisement inbox;
store one or more advertisements in an advertisement inbox;
identify the advertisement in the inbox based on the call service; and
retrieve the advertisement from the advertisement inbox.

78. The computer-readable medium of claim 75, wherein the call service is at least one of a caller identifier service, a call ring-back tone service, a call transfer service, a call hold service, and a call conferencing service.

79. The computer-readable medium of claim 75, wherein the advertisement is at least one of a static advertisement and an interactive advertisement.

80. The computer-readable medium of claim 75, wherein the advertisement is at least one of a text file, audio file, animation file, and video file.

81. The computer-readable medium of claim 75, wherein said codes are configured to transmit device location information to be used to select the advertisement.

82. The computer-readable medium of claim 75, wherein said codes are configured to receive user input in response to the advertisement.

83. The computer-readable medium of claim 82, wherein said codes are configured to perform at least one additional function based on the user input, wherein the additional function is selected from a set comprising:
requesting a new advertisement;
forwarding the advertisement;
deleting the advertisement;
storing the advertisement;
agreeing to the terms of the advertisement;
receiving the advertisement while ignoring the call service; and
receiving the call service while ignoring the advertisement.

84. The computer-readable medium of claim 82, wherein said codes are configured to receive at least one call incentive based on the user input, wherein the at least one call incentive is selected from a set comprising:
extending a duration of a call associated with a call service; and
reducing costs of the call.
